(19) United States
(12) Patent Application Publication
(10) Pub. No.: US 2024/0202518 A1
(43) Pub. Date: Jun. 20, 2024

(54) PRIVACY-PRESERVING GENERATION OF SYNTHESIZED TRAINING DATA

(71) Applicant: Microsoft Technology Licensing, LLC, Redmond, WA (US)

(72) Inventors: Jason Michael EISNER, Baltimore, MD (US); Eui Chul SHIN, San Francisco, CA (US); Fatemehsadat MIRESHGHALLAH, San Diego, CA (US); Tatsunori Benjamin HASHIMOTO, Palo Alto, CA (US); Yu SU, Columbus, OH (US)

(73) Assignee: Microsoft Technology Licensing, LLC, Redmond, WA (US)

(21) Appl. No.: 18/321,460

(22) Filed: May 22, 2023

Related U.S. Application Data
(60) Provisional application No. 63/476,072, filed on Dec. 19, 2022.

(51) Int. Cl. G06N 3/08

(52) U.S. Cl. CPC G06N 3/08

(57) ABSTRACT

Examples are disclosed that related to synthesizing a dataset of utterances in an automated manner using a computer while preserving user privacy. The synthesized dataset of utterances is usable to train a machine learning model. In one example, a differentially private parse tree generation model is trained based at least on private parse trees of a private utterance-parse tree dataset. A differentially private parse-to-utterance model is trained based at least on private utterances and corresponding private parse trees of the private utterance-parse tree dataset. A synthesized parse tree dataset is generated. The synthesized parse tree dataset includes synthesized parse trees sampled at random from the trained differentially private parse tree generation model. A synthesized utterance dataset is generated, via the trained differentially private parse-to-utterance model. The synthesized utterance dataset includes synthesized utterances that are generated based at least on the synthesized parse trees of the synthesized parse tree dataset.

### CROSS REFERENCE TO RELATED APPLICATIONS

This application claims priority to Provisional Patent Application No. 63/476,072, filed Dec. 19, 2022, the entirety of which is hereby incorporated herein by reference for all purposes.

### BACKGROUND

A task-oriented natural language dialogue model, such as employed by a virtual assistant or a chatbot, is trained to interact with a user in a manner that mimics a human. For example, the model may receive a user utterance and parse the user utterance into a semantic parse tree. The semantic parse tree is a representation of the syntactic structure of the user utterance that captures the meaning of the user utterance in a logical form. For example, a semantic parse tree can break down a user utterance into a hierarchy representing relationships between words and phrases and their corresponding meanings. The model may use the semantic parse tree as a tool to understand the meaning of a user utterance and/or derive a user's intent. The model may generate a response to the user utterance based at least on the semantic parse tree. By breaking down the user utterance into its constituent parts and their relationships, the semantic parse tree can provide a more detailed representation of the meaning of the user utterance than simply looking at words in the user utterance in isolation. This allows the model to generate an accurate and appropriate response to the user utterance in a manner that mimics a human.

### SUMMARY

Examples are disclosed that related to synthesizing a dataset of utterances in an automated manner using a computer while preserving user privacy. The synthesized dataset of utterances is usable to train a task-oriented natural language dialogue model. In one example, a differentially private parse tree generation model is trained based at least on private parse trees of a private utterance-parse tree dataset. A differentially private parse-to-utterance model is trained based at least on private utterances and corresponding private parse trees of the private utterance-parse tree dataset. A synthesized parse tree dataset is generated. The synthesized parse tree dataset includes synthesized parse trees sampled at random from the trained differentially private parse tree generation model. A synthesized utterance dataset is generated, via the trained differentially private parse-to-utterance model. The synthesized utterance dataset includes synthesized utterances that are generated based at least on the synthesized parse trees of the synthesized parse tree dataset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example scenario of a user interacting with a task-oriented natural language dialogue system executed by a computer.

FIG. 2 schematically shows an example training phase in which a differentially private parse tree generation model and a differentially private parse-to-utterance model are trained by a computing system of the present disclosure.

FIG. 3 schematically shows an example synthesized data generation phase in which a synthesized utterance dataset is generated, via a trained differentially private parse-to-utterance model implemented by the computing system of FIG. 2.

FIG. 4 schematically shows an example inference phase of a trained task-oriented natural language dialogue model trained on the synthesized utterance dataset generated during the synthesized data generation phase shown in FIG. 3.

FIGS. 5 and 6 show a flow chart of an example computer-implemented method for synthesizing a dataset of utterances while preserving user privacy.

FIG. 7 shows an example computing system of the present disclosure.

### DETAILED DESCRIPTION

Traditional task-oriented natural language dialogue models have limited linguistic coverage as well as functional coverage. Linguistic coverage refers to the range of linguistic phenomena that the model is capable of understanding and producing. It refers to how well the model can comprehend and generate language across various linguistic domains, such as syntax, semantics, pragmatics, morphology, and phonology. Functional coverage refers to the range of tasks or functions that the model is capable of performing. It measures how well the model can perform specific tasks within a given domain, such as answering questions, translating languages, summarizing text, or engaging in dialogue.

In many cases, the linguistic and functional coverage of a task-oriented natural language dialogue model is limited due to privacy controls associated with user data. As such, traditional task-oriented natural language dialogue models are typically trained using datasets that are limited and contrived, e.g., dialogues created by human crowd workers simulating users that interact with the task-oriented natural language dialogue models. This is a significant domain shift from real private user data that could potentially provide significantly greater linguistic coverage and functional coverage. In particular, unlabeled training data from real user interactions with task-oriented natural language dialogue models have abundant signals that could be used to improve the linguistic and functional coverage from a training perspective.

Note that training traditional task-oriented natural language dialogue models on actual user data generated from real user interactions can be problematic even if automated without human supervision. Trained models can “memorize” details of their training data, which can be exploited through different types of attacks that either extract full training sequences from models or infer the presence of a given sequence of interest in the training data that can be used to infringe on use privacy. Hence, enforcing privacy controls when using user data to train task-oriented natural language dialogue models helps protect user privacy.

Accordingly, the present disclosure is directed to a differentially private approach for synthesizing a training dataset that is used to train a task-oriented natural language dialogue model. Differential privacy can be achieved by adding random noise to the gradients computed during training. This noise is carefully calibrated so that the privacy of the individual users is preserved while still allowing the model to learn from the data. More particularly, such an approach exploits the structure of the output space by privately and separately modeling parse trees (as a differentially private parse tree generation model) and a conditional distribution of utterances given a parse tree (as a differentially private parse-to-utterance model). These models can then be used to generate as many samples as desired, by first sampling parse trees from the parse tree generation model and then prompting the parse-to-utterance model with these parse trees to generate synthesized utterances.

Such synthesized utterances are more fluent and diverse than that of contrived data generated by crowd workers trying to simulate user interactions. Moreover, such synthesized utterances have higher fidelity in relation to actual user utterances. In other words, such an approach reconstructs private user utterances as synthesized utterances that trigger the same behavior by a task-oriented natural language dialogue model as the original private user utterances. In this way, the synthesized utterances provide comparable training benefit as the original user utterances, but while also providing improved user privacy.

Such an approach provides the technical benefit of improving human computer interaction by generating synthesized training data in a manner that preserves user privacy while also providing a task-oriented natural language dialogue model trained on the synthesized training data with greater linguistic and functional coverage relative to a traditional model that is trained using training data generated by human crowd workers simulating user interactions or other privacy-preserving training methods.

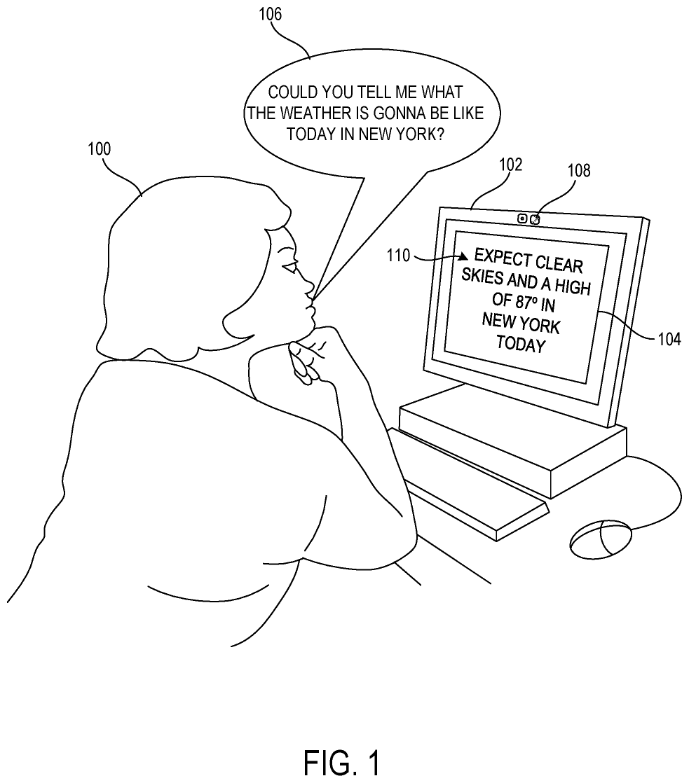

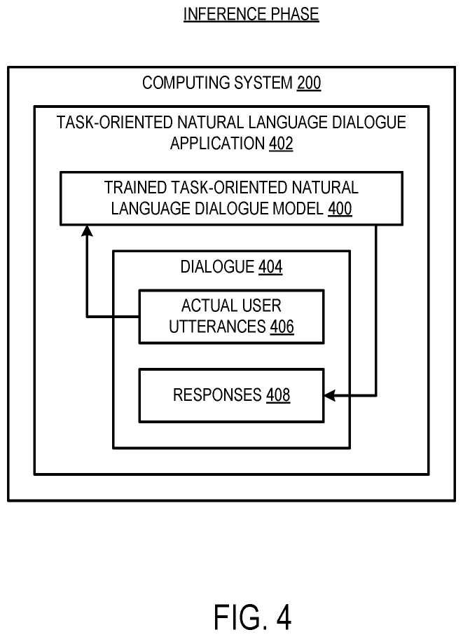

FIG. 1 shows an example scenario where a human subject 100 is interacting with a computer 102. The computer 102 executes a task-oriented natural language dialogue application 104, such as a virtual assistant application. The human subject 100 provides natural language input in the form of a user utterance 106 to the task-oriented natural language dialogue application 104. In particular, the human subject 100 states “Could you tell me what the weather is gonna be like today in New York?” The computer 102 includes a microphone 108 that captures the user utterance 106. The task-oriented natural language dialogue application 104 converts the user utterance 106 from speech to text and provides the text as input to a task-oriented natural language dialogue model 400 (shown in FIG. 4). The task-oriented natural language dialogue model 400 is trained based at least on a synthesized utterance dataset that is generated using the differentially private synthesized training data generation approach described herein. Such synthesized training data enables the task-oriented natural language dialogue model 400 to have greater linguistic and functional coverage relative to a traditional model that is trained using training data generated by human crowd workers simulating user interactions or other privacy-preserving training methods.

The task-oriented natural language dialogue model 400 generates a response 110 to the user utterance 106, which is displayed by the computer 102. In particular, the response 110 states “Expect clear skies and a high of 87º in New York today.”

In some implementations, the computer 102 is configured to execute the task-oriented natural language dialogue model 400 locally. In other implementations, the user utterance 106 may be converted into a computer-readable form and sent to a remote computing system (not shown) that executes the task-oriented natural language dialogue model 400 to generate the response 110 to the user utterance 106. The remote computing system may send the response 110 to the computer 102 for presentation to the human subject 100.

The concepts related to differentially private generation of synthesized training data for a task-oriented natural language dialogue model discussed herein are broadly applicable to any suitable type of computer or computing system including a cloud computing system, a desktop computer, a laptop computer, a mobile computing device (e.g., a smartphone), a wearable computing device, a mixed/augmented/virtual reality computing device, or another type of computer or computing system.

The user computer 102 is configured to collect computing information from the human subject 100 in strict accordance with user-authorized privacy settings. When applicable, the computing information may be anonymized or pseudo-anonymized in accordance with user-authorized privacy settings. Such information may include raw data, parameters derived from the raw data, and/or user-state metrics that are derived from the parameters/raw data.

Whenever user information is collected for any purpose, the user information is collected with the utmost respect for user privacy (e.g., user information is only collected after the user owning the information provides affirmative consent). Whenever information is stored, accessed, and/or processed, the information is handled in accordance with privacy and/or security standards to which the user has opted in. Prior to user information being collected, users may designate how the information is to be used and/or stored, and user information may only be used for the specific, objective-driven purposes for which the user has opted in. Users may opt-in and/or opt-out of information collection at any time. After information has been collected, users may issue a command to delete the information, and/or restrict access to the information. All potentially sensitive information optionally may be encrypted and/or, when feasible anonymized or pseudo-anonymized, to further protect user privacy. Users may optionally designate portions of data, metadata, or statistics/results of processing data for release to specific, user-selected other parties, e.g., for further processing. Information that is private and/or confidential may be kept completely private, e.g., only decrypted temporarily for processing, or only decrypted for processing on a user device and otherwise stored in encrypted form. Users may hold and control encryption keys for the encrypted information. Alternately or additionally, users may designate a trusted third party to hold and control encryption keys for the encrypted information, e.g., so as to provide access to the information to the user according to a suitable authentication protocol.

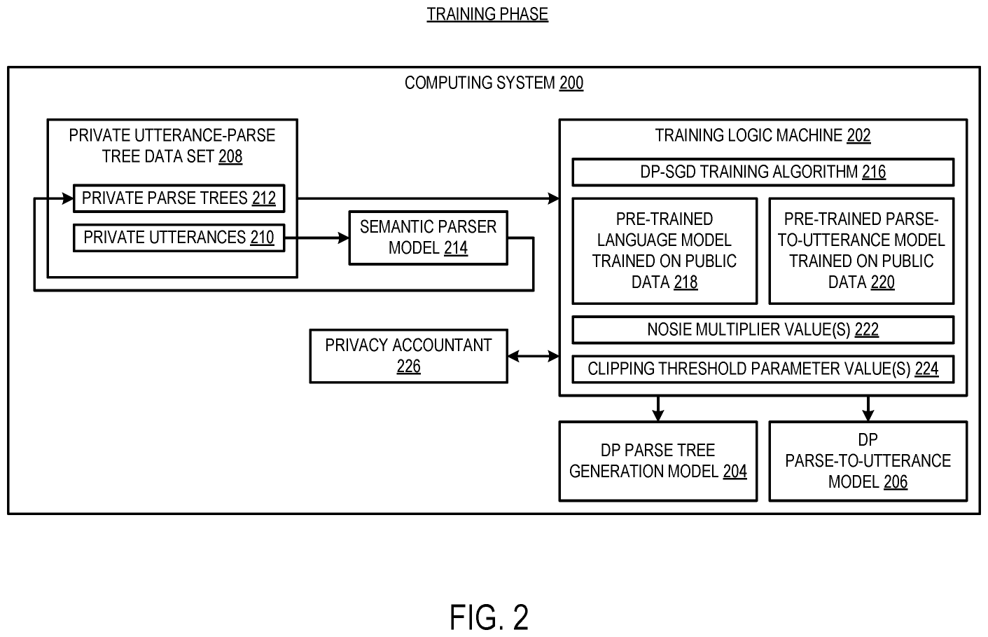

FIG. 2 schematically shows an example training phase in which a differentially private parse tree generation model and a differentially private parse-to-utterance model are trained by a computing system 200. The computing system 200 includes a training logic machine 202 configured to train a differentially private parse tree generation model 204 and a differentially private parse-to-utterance model 206 based at least on a private utterance-parse tree dataset 208. The private utterance-parse tree dataset 208 includes private utterances 210 and private parse trees 212 corresponding to the private utterances 210. In some examples, the private utterances 210 may include a set of unlabeled private user utterances drawn from a larger distribution of private user utterances.

In some implementations, the private parse trees 212 of the private utterance-parse tree dataset 208 are generated by a semantic parser model 214 based at least on the private utterances 210 of the private utterance-parse tree dataset 208. The semantic parser model 214 may be trained based at least on public training data/non-private training data that does not require any privacy protections. For example, the non-private training data may include only human utterances from dialogues (without any context) of a labeled public dataset of user interactions with a natural language model and parse trees corresponding to the user utterances. In one example, the semantic parser model 214 is a transformer-based semantic parser model. In other examples, the semantic parser model 214 may be another type of semantic parser model.

The training logic machine 202 is configured to train the differentially private parse tree generation model 204 based at least on private parse trees 212 of the private utterance-parse tree dataset 208. The training logic machine 202 is configured to train the differentially private parse-to-utterance model 206 based at least on the private utterances 210 and corresponding private parse trees 212 of the private utterance-parse tree dataset 208.

In some implementations, the training logic machine 202 is configured to train the differentially private parse tree generation model 204 and the differentially private parse-to-utterance model 206 using a differentially private stochastic gradient descent (DP-SGD) training algorithm 216 with privacy guarantees. The DP-SGD training algorithm 216 combines the concepts of stochastic gradient descent (SGD) and differential privacy (DP). Stochastic gradient descent is an optimization algorithm used in deep learning that updates a model's parameters based on the gradient of the loss function calculated on a small random batch of training data. This process is repeated multiple times until the model converges to a good solution. Differential privacy provides a mathematical framework for quantifying and controlling the privacy risk associated with the use of sensitive data. It ensures that the output of a machine learning algorithm does not reveal any information about individual training examples.

The DP-SGD training algorithm 216 combines these two concepts by adding noise to the gradients computed during the SGD optimization process, ensuring that the training process does not reveal information about individual training examples. The DP-SGD training algorithm 216 sets a privacy expenditure/budget (∈, δ) that defines a level of privacy used for training a model. ∈ is a measure of how much noise is added to gradient updates performed by the DP-SGD training algorithm 216. δ is a measure of the probability that the output of the DP-SGD training algorithm 216 is not differentially private. In other words, ∈ controls how difficult it is to distinguish between two datasets that differ by a single data point, and δ controls the probability that an entity can learn something about a particular data point even with the privacy guarantee. A higher value of ∈ means that more noise is added to the gradient updates, which makes it more difficult to distinguish between two datasets. However, a higher value of ∈ also means that the output of the DP-SGD training algorithm 216 is less accurate. A higher value of δ means that there is a higher probability that an entity can learn something about a particular data point, even with the privacy guarantee. However, a higher value of δ also means that the DP-SGD training algorithm 216 is more efficient. The choice of the values of the privacy budget (∈, δ) can depend on the specific application. For example, if the application requires a high level of privacy, then a small value of ∈ and a small value of δ can be used. However, if the application requires high accuracy, then a larger value of ∈ and a larger value of δ can be used.

The amount of noise added during training depends on a noise multiplier parameter value/a standard deviation of the noise (σ) 222 added to the gradient updates. A higher value of σ means that more noise is added, which makes it more difficult to distinguish between two datasets. However, a higher value of σ also means that the output of the DP-SGD training algorithm 216 is less accurate. The choice of σ can depend on the specific application. For example, if the application requires a high level of privacy, then a high value of σ can be used. However, if the application requires high accuracy, then a low value of σ can be used.

A clipping threshold parameter value (C) 224 controls a maximum magnitude of a gradient before adding noise at each update step. A higher value of C means that the gradients are more likely to be clipped, which can lead to lower accuracy. However, a higher value of C also means that the DP-SGD algorithm 216 is more efficient. The choice of the value of C can depend on the specific application. For example, if the application requires high accuracy, then a low value of C can be used. However, if the application requires high efficiency, then a high value of C can be used.

In one example, at each gradient update step, the DP-SGD training algorithm 216 clips the per-example gradient to a maximum norm of C, then the DP-SGD training algorithm 216 obfuscates it by adding Gaussian noise with mean 0 and standard deviation σ. This limits the contribution that a single example makes to the final model parameters. The privacy expenditure/budget of the DP-SGD training algorithm 216, (∈, δ), is a function of C, σ, |B| (batch size), |D| (dataset size), and the total number of epochs T (which controls the total number of gradient updates during training).

Note that training the models using differential privacy ensures that if an algorithm A satisfies (∈,δ)-DP, then so does F(A) for any function F, which means that any number of inferences can be run (samples can be taken from the output of the trained models) without changing the privacy expenditure for these models.

In some implementations where the training logic machine 202 uses the DP-SGD training algorithm 216 for training, the training logic machine 202 is configured to train the differentially private parse tree generation model 204 by fine-tuning a pre-trained language model 218 based at least on the parse trees 212 of the private utterance-parse tree dataset 208 using the DP-SGD training algorithm 216. The pre-trained language model 218 is trained using public training data/non-private training data that does not require any privacy protections. Further, in some implementations, the training logic machine 202 trains the differentially private parse-to-utterance model 206 by fine-tuning a pre-trained parse-to-utterance model 220 based at least on the private utterances 210 and the parse trees 212 of the private utterance-parse tree dataset 208 using the DP-SGD training algorithm 216. The pre-trained parse-to-utterance model 220 is trained using public training data/non-private training data that does not require any privacy protections.

In one example, the pre-trained language model 218 and the pre-trained parse-to-utterance model 220 are pre-trained GPT-2 models. In other examples, the pre-trained language model 218 and the pre-trained parse-to-utterance model 220 are different types of pre-trained models.

In some implementations, the training logic machine 202 is configured to train the differentially private parse tree generation model 204 and the differentially private parse-to-utterance model 206 independent of one another and in parallel. The technical feature of independent training and parallelization of the models provides the technical benefit of faster and more flexible training of the models.

The training logic machine 202 is configured to train the differentially private parse tree generation model 204 and the differentially private parse-to-utterance model 206 using one or more noise multiplier parameter values 222. The training logic machine 202 is configured to train the differentially private parse tree generation model 204 and the differentially private parse-to-utterance model 206 using one or more clipping threshold parameter values 224.

In some implementations, the training logic machine 202 is configured to train the differentially private parse tree generation model 204 and the differentially private parse-to-utterance model 206 using the same noise multiplier parameter value (σ) 222 and the same clipping threshold parameter values (C) 224. Additionally, in some implementations, the training logic machine 202 is configured split the total training epoch T into T1 and T2 to train the differentially private parse tree generation model 204 and the differentially private parse-to-utterance model 206. The split epochs and use of the same parameter values for (σ and C) for training of both models enables the training logic machine 202 to use a sophisticated privacy accountant 226 to monitor training of both of the models 204, 206.

The privacy accountant 226 helps to ensure that the level of noise added to during each training step is appropriate to maintain a certain level of privacy while still achieving an acceptable level of accuracy. In particular, the privacy accountant monitors the amount of noise that is added at each step of the training process and keeps track of the cumulative amount of privacy loss over time. This allows for the training logic machine 202 to adjust the parameters of the training process to achieve the desired level of privacy (∈, δ). By ensuring that the models 204, 206 are trained in a way that protects privacy while maintaining accuracy, the privacy accountant 226 helps to build trust in the use of machine learning in applications that handle sensitive data. By using a single shared privacy accountant to monitor training of both of the models 204, 206, the training processes can collectively benefit from sub-linear composition that allows for training for more total epochs, or with lower noise multipliers, than if the privacy budget (∈, δ) was divided directly between the two models 204, 206.

In some examples, the training logic machine 202 may divide the epochs T1 and T2 equally. In other examples, the training logic machine 202 may set T1 and T2 unequally. More particularly, the training logic machine 202 may set T2>T1. It is believed that increasing T2 at the expense of T1 steadily improves the quality of the generated text (under both text-based and parse-based metrics), until a tipping point is reached. It is believed that T1=2 and T2=8 epochs produce accurate results.

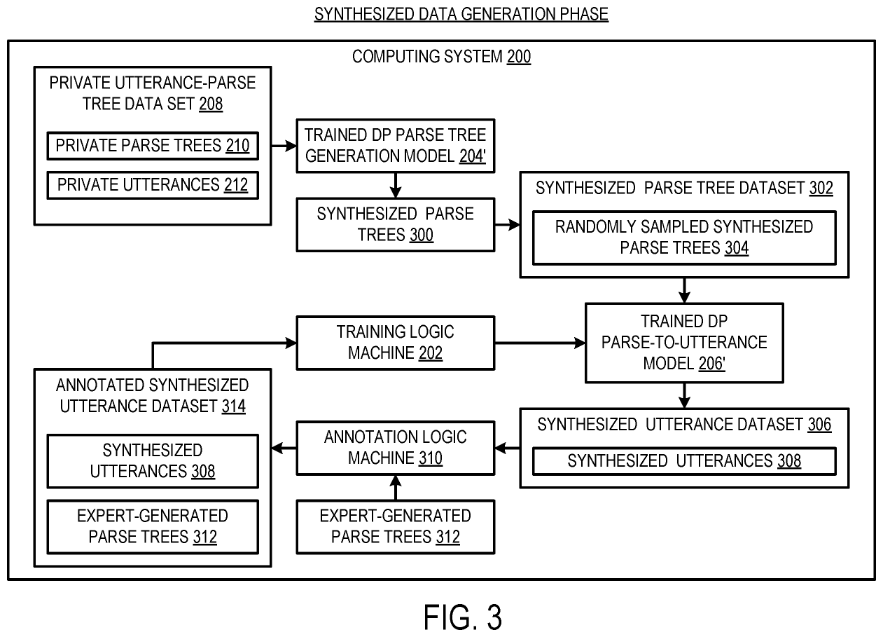

Once the training logic machine 202 trains the differentially private parse tree generation model 204 and the differentially private parse-to-utterance model 206, the computing system 200 transitions to a synthesized data generation phase shown in FIG. 3.

The trained differentially private parse tree generation model 204′ is configured to receive private utterances 210 of the private utterance-parse tree data set 208 as input and generate synthesized parse trees 300 based at least on the private utterances 210 of the private utterance-parse tree data set 208. The computing system 200 is configured to generate a synthesized parse tree dataset 302 including synthesized parse trees 304 sampled at random from output of the trained differentially private parse tree generation model 204′.

In some implementations, the synthesized parse tree dataset 302 may include synthesized parse trees sampled in a different manner than at random from the output of the trained differentially private parse tree generation model 204′.

The trained differentially private parse-to-utterance model 206′ is configured to receive the randomly sampled synthesized parse trees 304 as input and generate a synthesized utterance dataset 306 including synthesized utterances 308 based at least on the randomly sampled synthesized parse trees 304 of the synthesized parse tree dataset 302.

In some implementations, the computing system includes an annotation logic machine 310 configured to receive expert-generated parse trees 312 generated by experts that review the synthesized utterances 308 and generate the expert-generated parse trees 312 based at least on the synthesized utterances 308. The annotation logic machine 310 is configured to annotate the synthesized utterances 308 of the synthesized utterance dataset 306 with the corresponding expert-generated parse trees 312 to generate an annotated synthesized utterance dataset 314 that includes the synthesized utterances 308 and the corresponding expert-generated parse trees 312. The training logic machine 202 is configured to re-train the differentially private parse-to-utterance model 206′ based at least on the annotated synthesized utterance dataset 314. Such expert-generated annotation may improve the accuracy of the re-trained parse-to-utterance model 206′. Re-training the model 206′ based at least on the annotated synthesized utterance dataset 314 allows for the model 206′ to learn from these new and more accurate data and adjust its internal parameters or weights to better reflect the patterns in the new data. This can lead to improved accuracy, as the model 206′ is better able to generalize to new examples and make more accurate predictions. The model 206′ may be re-trained according to any suitable frequency as desired based on availability of the expert-generated parse trees 312.

The synthesized utterance dataset 306 can be used to train a task-oriented natural language dialogue model. FIG. 4 schematically shows an example inference phase of a trained task-oriented natural language dialogue model 400 trained on the synthesized utterance dataset 312 generated during the synthesized data generation phase shown in FIG. 3. The computing system 200 includes a task-oriented natural language dialogue application 402 configured to execute the trained task-oriented natural language dialogue model 400. For example, the task-oriented natural language dialogue application 402 may be representative of the task-oriented natural language dialogue application 104 shown in FIG. 1. The task-oriented natural language dialogue application 402 is configured to generate a dialogue 404 that allows for a conversation or exchange of information between a user and the computing system 200. The task-oriented natural language dialogue application 402 is configured to receive actual user utterances 406 from the user and provide the actual user utterances 406 as input to the trained task-oriented natural language dialogue model 400. The trained task-oriented natural language dialogue model 400 is configured to generate corresponding responses 408 based at least on the actual user utterances 406. The task-oriented natural language dialogue application 402 is configured to present the actual user utterances 406 and the corresponding responses 408 in the dialogue 404.

Note that the synthesized utterance dataset 306 may be used to train any suitable type of natural language model. Further, note that such a trained natural language model trained based at least on the synthesized utterance dataset 306 may be executed on a computer or computing system other than the computing system 200. In one example, the computing system 200 may be a cloud computing system that trains the various machine learning models discussed herein, and the trained machine learning models may be distributed to other types of computers for local execution by those computers.

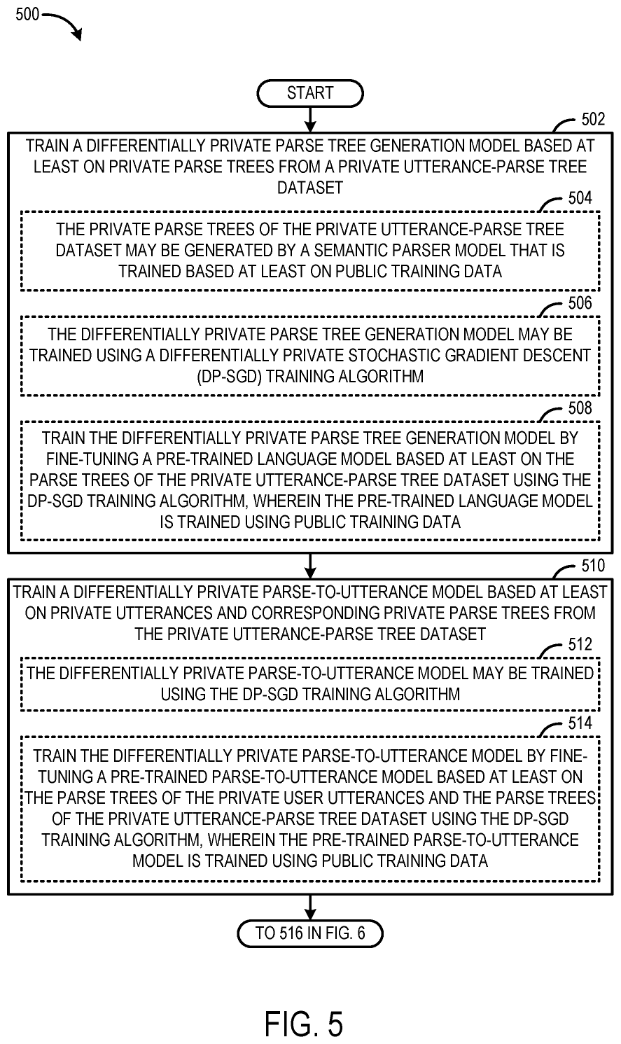

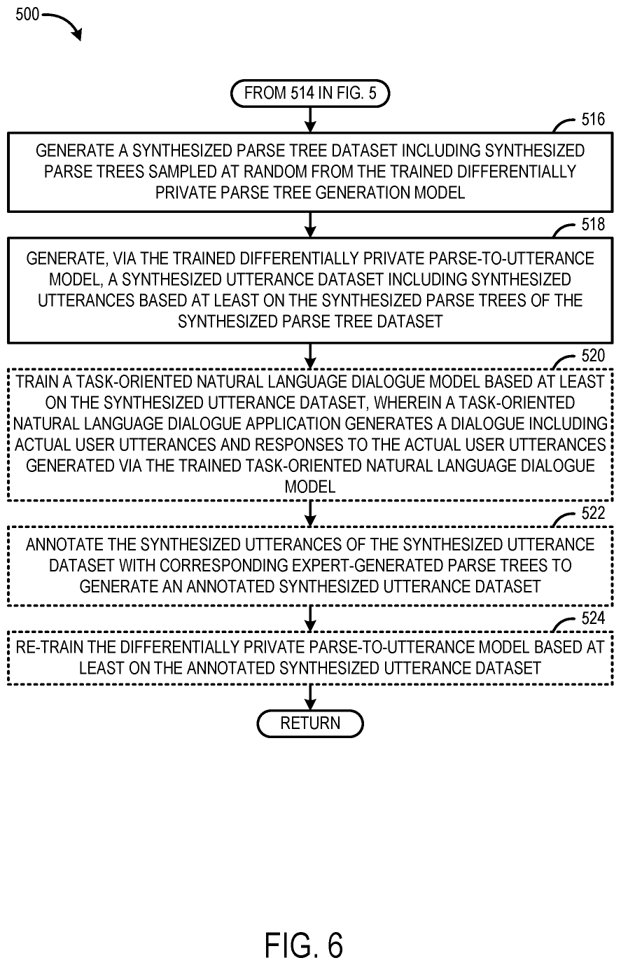

FIGS. 5 and 6 show a flow chart of an example computer-implemented method 500 for synthesizing a dataset of utterances while preserving user privacy. For example, the computer-implemented method 500 may be performed by the computing system 200 or another computer or computing system.

In FIG. 5, at 502, the computer-implemented method 500 includes training a differentially private parse tree generation model based at least on private parse trees of a private utterance-parse tree dataset.

In some implementations, at 504, the private parse trees of the private utterance-parse tree dataset may be generated by a semantic parser model based at least on the private utterances of the private utterance-parse tree dataset, wherein the semantic parser model is trained based at least on public training data/non-private training data that does not require any privacy protections.

In some implementations, at 506, the differentially private parse tree generation model may be trained using a differentially private stochastic gradient descent (DP-SGD) training algorithm.

In some implementations, at 508, the computer-implemented method 500 may include training the differentially private parse tree generation model by fine-tuning a pre-trained language model based at least on the parse trees of the private utterance-parse tree dataset using the DP-SGD training algorithm. The pre-trained language model is trained using public training data/non-private training data that does not require any privacy protections.

At 510, the computer-implemented method 500 includes training a differentially private parse-to-utterance model based at least on private utterances and corresponding private parse trees of the private utterance-parse tree dataset.

In some implementations, at 512, the differentially private parse-to-utterance model may be trained using the DP-SGD training algorithm.

In some implementations, at 514, the computer-implemented method 500 may include training the differentially private parse-to-utterance model by fine-tuning a pre-trained parse-to-utterance model based at least on the private user utterances and the parse trees of the private utterance-parse tree dataset using the DP-SGD training algorithm. The pre-trained parse-to-utterance model is trained using public training data/non-private training data that does not require any privacy protections.

In FIG. 6, at 516 the computer-implemented method 500 includes generating a synthesized parse tree dataset including synthesized parse trees sampled at random from the trained differentially private parse tree generation model.

At 518, the computer-implemented method 500 includes generating, via the trained differentially private parse-to-utterance model, a synthesized utterance dataset including synthesized utterances based at least on the synthesized parse trees of the synthesized parse tree dataset.

In some implementations, at 520, the computer-implemented method 500 may include training a task-oriented natural language dialogue model based at least on the synthesized utterance dataset, wherein a task-oriented natural language dialogue application generates a dialogue including actual user utterances and responses to the actual user utterances generated via the trained task-oriented natural language dialogue model.

In some implementations, at 522, the computer-implemented method 500 may include annotating the synthesized utterances of the synthesized utterance dataset with corresponding expert-generated parse trees to generate an annotated synthesized utterance dataset.

In some implementations, at 524, the computer-implemented method 500 may include re-training the differentially private parse-to-utterance model based at least on the annotated synthesized utterance dataset.

The computer-implemented method 500 may be performed to generate synthesized utterances for training natural language models while preserving user privacy. A natural language model trained on the synthesized utterances generated according to the computer-implemented method 500 may have increased linguistic and functional coverage relative to a model trained using training data generated by crowd workers trying to simulate user interactions. Moreover, such synthesized utterances have higher fidelity in relation to actual user utterances. In other words, such an approach reconstructs private user utterances as synthesized utterances that trigger the same behavior by a task-oriented natural language dialogue model as the original private user utterances. In this way, the synthesized utterances provide comparable training benefit as the original user utterances, but while also providing improved user privacy.

In some implementations, the methods and processes described herein may be tied to a computing system of one or more computing devices. In particular, such methods and processes may be implemented as a computer-application program or service, an application-programming interface (API), a library, and/or other computer-program product.

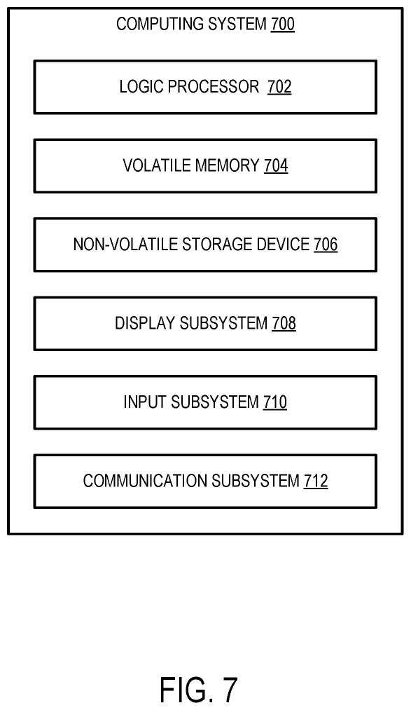

FIG. 7 schematically shows a non-limiting implementation of a computing system 700 that can enact one or more of the methods and processes described above. Computing system 700 is shown in simplified form. Computing system 700 may embody the computer 102 shown in FIG. 1 and the computing system 200 shown in FIG. 2. Computing system 700 may take the form of one or more personal computers, server computers, tablet computers, network computing devices, cloud computing devices, mobile computing devices, mobile communication devices (e.g., smart phone), wearable computing devices such as smart wristwatches and head mounted augmented reality devices, and/or other computing devices.

Computing system 700 includes a logic processor 702, volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The logic processor 702, volatile memory 704, and/or non-volatile storage device 706 may cooperate to instantiate one or more logic machines. As used herein, the terms “machine” (e.g., training logic machine, annotation logic machine) and “machine learning model” (e.g., semantic parser, pre-trained language model, pre-trained parse-to-utterance model, differentially private parse tree generation model, differentially private parse-to-utterance model, and task-oriented natural language dialogue model) are used to collectively refer to the combination of hardware, firmware, software, instructions, and/or any other components cooperating to provide computer functionality. In other words, “machines” and “models” are never abstract ideas and always have a tangible form. A machine and/or model may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), Transformer-based machine learning models (e.g., Bidirectional Representations from Transformers), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based at least on classes derived from unsupervised clustering methods), reinforcement learning (e.g., deep Q learning based at least on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

Language models may utilize vocabulary features to guide sampling/searching for words for recognition of speech. For example, a language model may be at least partially defined by a statistical distribution of words or other vocabulary features. For example, a language model may be defined by a statistical distribution of n-grams, defining transition probabilities between candidate words according to vocabulary statistics. The language model may be further based at least on any other appropriate statistical features, and/or results of processing the statistical features with one or more machine learning and/or statistical algorithms (e.g., confidence values resulting from such processing). In some examples, a statistical model may constrain what words may be recognized for an audio signal, e.g., based at least on an assumption that words in the audio signal come from a particular vocabulary.

Alternately or additionally, the language model may be based at least on one or more neural networks previously trained to represent audio inputs and words in a shared latent space, e.g., a vector space learned by one or more audio and/or word models (e.g., wav2letter and/or word2vec). Accordingly, finding a candidate word may include searching the shared latent space based at least on a vector encoded by the audio model for an audio input, in order to find a candidate word vector for decoding with the word model. The shared latent space may be utilized to assess, for one or more candidate words, a confidence that the candidate word is featured in the speech audio.

The language model may be used in conjunction with an acoustical model configured to assess, for a candidate word and an audio signal, a confidence that the candidate word is included in speech audio in the audio signal based at least on acoustical features of the word (e.g., mel-frequency cepstral coefficients, formants, etc.). Optionally, in some examples, the language model may incorporate the acoustical model (e.g., assessment and/or training of the language model may be based at least on the acoustical model). The acoustical model defines a mapping between acoustic signals and basic sound units such as phonemes, e.g., based at least on labelled speech audio. The acoustical model may be based at least on any suitable combination of state-of-the-art or future machine learning (ML) and/or artificial intelligence (AI) models, for example: deep neural networks (e.g., long short-term memory, temporal convolutional neural network, restricted Boltzmann machine, deep belief network), hidden Markov models (HMM), conditional random fields (CRF) and/or Markov random fields, Gaussian mixture models, and/or other graphical models (e.g., deep Bayesian network). Audio signals to be processed with the acoustic model may be pre-processed in any suitable manner, e.g., encoding at any suitable sampling rate, Fourier transform, band-pass filters, etc. The acoustical model may be trained to recognize the mapping between acoustic signals and sound units based at least on training with labelled audio data. For example, the acoustical model may be trained based at least on labelled audio data comprising speech audio and corrected text, in order to learn the mapping between the speech audio signals and sound units denoted by the corrected text. Accordingly, the acoustical model may be continually improved to improve its utility for correctly recognizing speech audio.

In some examples, in addition to statistical models, neural networks, and/or acoustical models, the language model may incorporate any suitable graphical model, e.g., a hidden Markov model (HMM) or a conditional random field (CRF). The graphical model may utilize statistical features (e.g., transition probabilities) and/or confidence values to determine a probability of recognizing a word, given the speech audio and/or other words recognized so far. Accordingly, the graphical model may utilize the statistical features, previously trained machine learning models, and/or acoustical models to define transition probabilities between states represented in the graphical model.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some implementations, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some implementations, the communication subsystem may allow computing system 700 to send and/or receive messages to and/or from other devices via a network such as the Internet.

In an example, a computing system comprises one or more processors configured to execute instructions stored in memory to train a differentially private parse tree generation model based at least on private parse trees of a private utterance-parse tree dataset, train a differentially private parse-to-utterance model based at least on private utterances and corresponding private parse trees of the private utterance-parse tree dataset, generate a synthesized parse tree dataset including synthesized parse trees sampled at random from the trained differentially private parse tree generation model, and generate, via the trained differentially private parse-to-utterance model, a synthesized utterance dataset including synthesized utterances based at least on the synthesized parse trees of the synthesized parse tree dataset. In this example and/or other examples, the private parse trees of the private utterance-parse tree dataset may be generated by a semantic parser model based at least on the private utterances of the private utterance-parse tree dataset, the semantic parser model may be trained based at least on public training data. In this example and/or other examples, the differentially private parse tree generation model and the differentially private parse-to-utterance model may be trained using a differentially private stochastic gradient descent (DP-SGD) training algorithm. In this example and/or other examples, training the differentially private parse tree generation model may include fine-tuning a pre-trained language model based at least on the parse trees of the private utterance-parse tree dataset using the DP-SGD training algorithm, the pre-trained language model may be trained using public training data, training the differentially private parse-to-utterance model may include fine-tuning a pre-trained parse-to-utterance model based at least on the private user utterances and the parse trees of the private utterance-parse tree dataset using the DP-SGD training algorithm, and the pre-trained parse-to-utterance model may be trained using public training data. In this example and/or other examples, the one or more processors may be configured to execute instructions stored in the memory to annotate the synthesized utterances of the synthesized utterance dataset with corresponding expert-generated parse trees to generate an annotated synthesized utterance dataset, and re-train the differentially private parse-to-utterance model based at least on the annotated synthesized utterance dataset. In this example and/or other examples, the differentially private parse tree generation model and the differentially private parse-to-utterance model may be trained independent of one another and in parallel. In this example and/or other examples, the differentially private parse tree generation model and the differentially private parse-to-utterance model may be trained using a same noise multiplier parameter value and a same clipping threshold parameter value. In this example and/or other examples, a task-oriented natural language dialogue model may be trained based at least on the synthesized utterance dataset, a task-oriented natural language dialogue application may generate a dialogue including actual user utterances and responses to the actual user utterances generated via the trained task-oriented natural language dialogue model.

In another example, a computer-implemented method for synthesizing a dataset of utterances while preserving user privacy, the computer-implemented method comprises training a differentially private parse tree generation model based at least on private parse trees of a private utterance-parse tree dataset, training a differentially private parse-to-utterance model based at least on private utterances and corresponding private parse trees of the private utterance-parse tree dataset, generating a synthesized parse tree dataset including synthesized parse trees sampled at random from the trained differentially private parse tree generation model, and generating, via the trained differentially private parse-to-utterance model, a synthesized utterance dataset including synthesized utterances based at least on the synthesized parse trees of the synthesized parse tree dataset. In this example and/or other examples, the private parse trees of the private utterance-parse tree dataset may be generated by a semantic parser model based at least on the private utterances of the private utterance-parse tree dataset, the semantic parser model may be trained based at least on public training data. In this example and/or other examples, the differentially private parse tree generation model and the differentially private parse-to-utterance model may be trained using a differentially private stochastic gradient descent (DP-SGD) training algorithm. In this example and/or other examples, training the differentially private parse tree generation model may include fine-tuning a pre-trained language model based at least on the parse trees of the private utterance-parse tree dataset using the DP-SGD training algorithm, the pretrained language model may be trained using public training data, training the differentially private parse-to-utterance model may include fine-tuning a pre-trained parse-to-utterance model based at least on the private user utterances and the parse trees of the private utterance-parse tree dataset using the DP-SGD training algorithm, and the pre-trained parse-to-utterance model is trained using public training data. In this example and/or other examples, the computer-implemented method further comprises annotating the synthesized utterances of the synthesized utterance dataset with corresponding expert-generated parse trees to generate an annotated synthesized utterance dataset, and re-training the differentially private parse-to-utterance model based at least on the annotated synthesized utterance dataset. In this example and/or other examples, the differentially private parse tree generation model and the differentially private parse-to-utterance model may be trained independent of one another and in parallel. In this example and/or other examples, the differentially private parse tree generation model and the differentially private parse-to-utterance model may be trained using a same noise multiplier parameter value and a same clipping threshold parameter value. In this example and/or other examples, a task-oriented natural language dialogue model may be trained based at least on the synthesized utterance dataset, a task-oriented natural language dialogue application may generate a dialogue including actual user utterances and responses to the actual user utterances generated via the trained task-oriented natural language dialogue model.

In yet another example, a computing system comprises one or more processors configured to execute instructions stored in memory to train a differentially private parse tree generation model based at least on private parse trees of a private utterance-parse tree dataset, train a differentially private parse-to-utterance model based at least on private utterances and corresponding private parse trees of the private utterance-parse tree dataset, generate a synthesized parse tree dataset including synthesized parse trees sampled at random from the trained differentially private parse tree generation model, generate, via the trained differentially private parse-to-utterance model, a synthesized utterance dataset including synthesized utterances based at least on the synthesized parse trees of the synthesized parse tree dataset, annotate the synthesized utterances of the synthesized utterance dataset with corresponding expert-generated parse trees, and re-train the differentially private parse-to-utterance model based at least on the annotated synthesized utterance dataset. In this example and/or other examples, the private parse trees of the private utterance-parse tree dataset may be generated by a semantic parser model based at least on the private utterances of the private utterance-parse tree dataset, the semantic parser model may be trained based at least on public training data. In this example and/or other examples, the differentially private parse tree generation model and the differentially private parse-to-utterance model may be trained using a differentially private stochastic gradient descent (DP-SGD) training algorithm. In this example and/or other examples, training the differentially private parse tree generation model may include fine-tuning a pre-trained language model based at least on the parse trees of the private utterance-parse tree dataset using the DP-SGD training algorithm, the pre-trained language model may be trained using public training data, training the differentially private parse-to-utterance model may include fine-tuning a pre-trained parse-to-utterance model based at least on the private user utterances and the parse trees of the private utterance-parse tree dataset using the DP-SGD training algorithm, and the pre-trained parse-to-utterance model may be trained using public training data.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processors configured to execute instructions stored in memory to:
train a differentially private parse tree generation model based at least on private parse trees of a private utterance-parse tree dataset;
train a differentially private parse-to-utterance model based at least on private utterances and corresponding private parse trees of the private utterance-parse tree dataset;
generate a synthesized parse tree dataset including synthesized parse trees sampled at random from the trained differentially private parse tree generation model; and
generate, via the trained differentially private parse-to-utterance model, a synthesized utterance dataset including synthesized utterances based at least on the synthesized parse trees of the synthesized parse tree dataset.

2. The computing system of claim 1, wherein the private parse trees of the private utterance-parse tree dataset are generated by a semantic parser model based at least on the private utterances of the private utterance-parse tree dataset, wherein the semantic parser model is trained based at least on public training data.

3. The computing system of claim 1, wherein the differentially private parse tree generation model and the differentially private parse-to-utterance model are algorithm.

4. The computing system of claim 3, wherein training the differentially private parse tree generation model includes fine-tuning a pre-trained language model based at least on the parse trees of the private utterance-parse tree dataset using the DP-SGD training algorithm, wherein the pre-trained language model is trained using public training data, wherein training the differentially private parse-to-utterance model includes fine-tuning a pre-trained parse-to-utterance model based at least on the private user utterances and the parse trees of the private utterance-parse tree dataset using the DP-SGD training algorithm, and wherein the pre-trained parse-to-utterance model is trained using public training data.

5. The computing system of claim 1, wherein the one or more processors are configured to execute instructions stored in the memory to:
annotate the synthesized utterances of the synthesized utterance dataset with corresponding expert-generated parse trees to generate an annotated synthesized utterance dataset; and
re-train the differentially private parse-to-utterance model based at least on the annotated synthesized utterance dataset.

6. The computing system of claim 1, wherein the differentially private parse tree generation model and the differentially private parse-to-utterance model are trained independent of one another and in parallel.

7. The computing system of claim 1, wherein the differentially private parse tree generation model and the differentially private parse-to-utterance model are trained using a same noise multiplier parameter value and a same clipping threshold parameter value.

8. The computing system of claim 1, wherein a task-oriented natural language dialogue model is trained based at least on the synthesized utterance dataset, wherein a task-oriented natural language dialogue application generates a dialogue including actual user utterances and responses to the actual user utterances generated via the trained task-oriented natural language dialogue model.

9. A computer-implemented method for synthesizing a dataset of utterances while preserving user privacy, the computer-implemented method comprising:
training a differentially private parse tree generation model based at least on private parse trees of a private utterance-parse tree dataset;
training a differentially private parse-to-utterance model based at least on private utterances and corresponding private parse trees of the private utterance-parse tree dataset;
generating a synthesized parse tree dataset including synthesized parse trees sampled at random from the trained differentially private parse tree generation model; and
generating, via the trained differentially private parse-to-utterance model, a synthesized utterance dataset including synthesized utterances based at least on the synthesized parse trees of the synthesized parse tree dataset.

10. The computer-implemented method of claim 9, wherein the private parse trees of the private utterance-parse tree dataset are generated by a semantic parser model based at least on the private utterances of the private utterance-parse tree dataset, wherein the semantic parser model is trained based at least on public training data.

11. The computer-implemented method of claim 9, wherein the differentially private parse tree generation model and the differentially private parse-to-utterance model are trained using a differentially private stochastic gradient descent (DP-SGD) training algorithm.

12. The computer-implemented method of claim 11, wherein training the differentially private parse tree generation model includes fine-tuning a pre-trained language model based at least on the parse trees of the private utterance-parse tree dataset using the DP-SGD training algorithm, wherein the pretrained language model is trained using public training data, wherein training the differentially private parse-to-utterance model includes fine-tuning a pre-trained parse-to-utterance model based at least on the private user utterances and the parse trees of the private utterance-parse tree dataset using the DP-SGD training algorithm, and wherein the pre-trained parse-to-utterance model is trained using public training data.

13. The computer-implemented method of claim 11, further comprising:
annotating the synthesized utterances of the synthesized utterance dataset with corresponding expert-generated parse trees to generate an annotated synthesized utterance dataset; and
re-training the differentially private parse-to-utterance model based at least on the annotated synthesized utterance dataset.

14. The computer-implemented method of claim 9, wherein the differentially private parse tree generation model and the differentially private parse-to-utterance model are trained independent of one another and in parallel.

15. The computer-implemented method of claim 9, wherein the differentially private parse tree generation model and the differentially private parse-to-utterance model are trained using a same noise multiplier parameter value and a same clipping threshold parameter value.

16. The computer-implemented method of claim 9, wherein a task-oriented natural language dialogue model is trained based at least on the synthesized utterance dataset, wherein a task-oriented natural language dialogue application generates a dialogue including actual user utterances and responses to the actual user utterances generated via the trained task-oriented natural language dialogue model.

17. A computing system comprising:
one or more processors configured to execute instructions stored in memory to:
train a differentially private parse tree generation model based at least on private parse trees of a private utterance-parse tree dataset;
train a differentially private parse-to-utterance model based at least on private utterances and corresponding private parse trees of the private utterance-parse tree dataset;
generate a synthesized parse tree dataset including synthesized parse trees sampled at random from the trained differentially private parse tree generation model;
generate, via the trained differentially private parse-to-utterance model, a synthesized utterance dataset including synthesized utterances based at least on the synthesized parse trees of the synthesized parse tree dataset;
annotate the synthesized utterances of the synthesized utterance dataset with corresponding expert-generated parse trees; and
re-train the differentially private parse-to-utterance model based at least on the annotated synthesized utterance dataset.

18. The computing system of claim 17, wherein the private parse trees of the private utterance-parse tree dataset are generated by a semantic parser model based at least on the private utterances of the private utterance-parse tree dataset, wherein the semantic parser model is trained based at least on public training data.

19. The computing system of claim 17, wherein the differentially private parse tree generation model and the differentially private parse-to-utterance model are algorithm.

20. The computing system of claim 19, wherein training the differentially private parse tree generation model includes fine-tuning a pre-trained language model based at least on the parse trees of the private utterance-parse tree dataset using the DP-SGD training algorithm, wherein the pre-trained language model is trained using public training data, wherein training the differentially private parse-to-utterance model includes fine-tuning a pre-trained parse-to-utterance model based at least on the private user utterances and the parse trees of the private utterance-parse tree dataset using the DP-SGD training algorithm, and wherein the pre-trained parse-to-utterance model is trained using public training data.
